(19) United States
(12) Patent Application Publication
(10) Pub. No.: US 2010/0187815 A1
(43) Pub. Date: Jul. 29, 2010

(54) HOSE FITTING AND METHOD FOR FASTENING THE HOSE FITTING TO A HOSE

(75) Inventors: Bjoern Theberath, Kuppenheim (DE); Juergen Schmidt, Rastatt (DE); Eric Thomas Scherer, Oetigheim (DE)

Correspondence Address: DYKEMA GOSSETT PLLC, 39577 WOODWARD AVENUE, SUITE 300, BLOOMFIELD HILLS, MI, 48304-5086, US

(73) Assignee: EATON FLUID POWER GMBH, Baden-Baden (DE)

(21) Appl. No.: 12/695,721

(22) Filed: Jan. 28, 2010

(30) Foreign Application Priority Data
Jan. 29, 2009 (EP) 09151675.7

(51) Int. Cl. F16L 33/01

(52) U.S. Cl. 285/256

(57) ABSTRACT

A hose fitting and a method for fastening a hose fitting to a hose end section are disclosed. The hose fitting includes a connecting element and holding sleeve. The connecting element includes an insert section configured to be inserted into the hose end section. The holding sleeve includes a fixing section with a fixing part to engage a fixing counter part of the connecting element to fix the holding sleeve to the connecting element. A holding section of the holding sleeve may include radially inward projecting holding projections. The fixing and holding sections may be connected via an intermediate section arranged therebetween. In the fastened state, where the hose fitting is fastened to the hose end section, the holding projection may intrude into an outer sheathing of the hose end section. A clearance can be created between the hose end and the fixing part in the fastened state.

### CROSS-REFERENCE TO RELATED APPLICATION

This application claims the benefit of priority to European Patent Application No. 09151675.7, filed Jan. 29, 2009. This European application is hereby incorporated by reference as though fully set forth herein.

### BACKGROUND

The present invention refers to a hose fitting, in particular for flexible wire reinforced hoses and a method for fastening a hose fitting to hose end section of a hose. Such hose fittings provide a sealing connection between the hose fitting and the respective end section of a hose, even if the hose is under high fluid pressure. For high pressure applications wire reinforced hoses are often used which have an outer sheathing, an inner sheathing and a reinforcement layer, particularly containing metal wires, between the two sheathings. The hose fittings are required to be cheap, easy to produce and easy to mount on the end section of a hose.

Several different hose fittings are already known. GB 2 000 840 A discloses a hose fitting in form of a hose-end connector for a thermoplastics material hose having no metal reinforcement. The hose fitting contains a stem portion and ferrule which is swaged to the stem portion in two assembly stages. During the first stage a flange portion of the ferrule is swaged into locking engagement with an annular groove in the stem portion. Afterwards in a second assembly stage a main body portion of the ferrule swaged onto a hose located in an annulus between the stem portion and ferrule. In this second assembly stage, the swaging force compresses the hose wall. As all of the stem and ferrule zones which contact the inner and outer walls of the hose are rounded, there is no tendency for the hose material to be severed and the compression force causes the material of the hose wall to flow. In the fastened state where the hose fitting is fastened to the end section of the hose, the annulus between the ferrule and the stem is completely filled with the hose material.

Another hose fitting is known from US 2006/0131878 A1 comprising a coupling element, a press fit holder and an insert. Before the hose fitting can be assembled to the hose end section, the latter is peeled. An external pressure acting on the press fit holder results in a compression of the press fit holder and the insert surrounded by the press fit holder. Hose gripping means at the inside of the insert are thereby pressed into the wire mesh of the hose end section. The external pressure causes also fixing means of the press fit holder to come into engagement with counter fixing means of the coupling element.

FR 1 227 889 B discloses a hose fitting with a holding sleeve consisting of several sections. These section have a grooved axial end which is link like inserted between the connecting element and an additional fixing ring. Flanges with screwing holes are provided at the outer plane of each section which serve to detachably connect the sections. After all section are inserted between the fixing ring and the connecting element the sections can be screwed together.

It is an aspect of the present invention to provide a hose fitting, suitable for high pressure applications, which can be easily mounted on the hose end section, and which can be pre-assembled and easily mounted on a hose end section without the need to peel the latter.

This challenge may be addressed by hose fittings and methods such as taught in accordance with the present invention.

### SUMMARY

A hose fitting according to embodiments of the invention may comprise a connecting element and a holding sleeve. The holding sleeve may have a deformable fixing section at one end with a fixing part provided to engage a fixing counter part of the connecting element. By applying a crimp force onto the fixing section of the holding sleeve, the fixing part and a counter fixing part can be brought into engagement in order to pre-assemble the holding sleeve with the connecting element. No additional fixing means are necessary to fix the holding sleeve to the connecting element. Thus it is possible that the hose fitting consists of only two parts: the holding sleeve and the connecting element. Each of said parts can be made of one single piece. The holding sleeve can be jointless in its circumferential direction. The holding sleeve may have a ring shaped cross section at every point along its axial direction. The outer plane of the holding sleeve may be flange—or projectionless formed.

To fasten the hose fitting to the hose end section of a respective hose, an insert section of the connecting element may be inserted into the opening of the hose end section until the hose end reaches a stop projection on the outside face of the connecting element. The hose end section may be unpeeled so that an outer sheathing, particularly made of plastic or elastomer, provides material as counter part for a holding section of the holding sleeve comprising radially inward projecting holding projections, each holding projection having at least one cutting edge. If a crimp force is now applied to the deformable holding section of the holding sleeve, the cutting edges of the holding projections cut into the outer surface of the hose end section and intrude into the outer sheathing of the hose end section. Thus, the hose end section may be fixed by the holding projections. In the fastened state of the hose fitting an axially clearance between the hose end and the fixing part of the holding sleeve can be created. This clearance may be bridged by providing an intermediate section between the fixing section and the holding section of the holding sleeve.

The hose fitting is easy to produce and can be pre-assembled without the danger to crimp the holding section, when the fixing section of the holding sleeve is fixed to the connecting element. The intermediate section between the fixing section and the holding section may provide enough distance between the fixing part and the holding projections, that during crimping or swaging the fixing part into engagement with the counter fixing part, the holding section and its holding projections remain in their unchanged original position. This may be important for some embodiments to be able to insert the hose end section between the insert section of the connecting element and the deformable holding section of the holding sleeve in the next mounting step. Further the hose end section can remain unpeeled, which makes it very easy to bring the hose fitting in a fastened state, where it is fastened to the hose end section. Because the holding projections cut and insert into the outer sheathing of the hose end section, a very strong connection between the hose fitting and the hose can be achieved, which is also suitable for high pressure applications.

According to a an embodiment, the axial length of the clearance may be greater than the axial distance between two adjacent arranged holding projections. The axial length of the clearance can be, for example, between 1.5 and 2 times longer than the distance between adjacent holding projections. In the fastened state of the hose fitting, the axial length of the clearance can, for example, be between 1 or 3 cm, particularly 2 cm. The axial length of the intermediate section of the holding sleeve is chosen respectively. This provides a good decoupling of the fixing section and the holding section.

In a further embodiment, the intermediate section may be at least partly conically shaped, particularly if the hose fitting is in its fastened state. Advantageously, the outside diameter of the holding section may be greater than the outside diameter of the fixing section. The greater diameter of the holding section makes it possible to insert the hose end section between the insert section of the connecting element and the holding section of the holding sleeve without the need to peel the hose end section. An easy connection between the fixing section and the holding section of the holding sleeve can be made by means of an intermediate section which is at least partly conically shaped.

Favourably, the wall of the intermediate section of the holding sleeve may have an essentially constant thickness. In other words, for such an embodiment, there are no projections or openings provided in the wall of the intermediate section of the holding sleeve, so that a simple form of the holding sleeve can be achieved.

In the fastened state of the hose fitting, an annular gap around the connecting element may be created because of the clearance between the hose end and the fixing part and the radially distance between the intermediate section of the holding sleeve and the connecting element.

It may be preferable for some high pressure applications to use the hose fitting with a reinforced hose having a reinforcement layer in between an outer sheathing and an inner sheathing. The reinforcement layer particularly may contain metal wires. In the fastened state, if the hose fitting is fastened to such a reinforced hose, the holding projections may intrude into the outer sheathing of the hose end section until the radially inner ends of the holding projections reach the reinforcement layer. This may provide a further improved connection between the hose fitting and the hose.

It is also possible, that the holding sleeve may provide a clamping projection, which can project radially inward from the holding section and which may be axially arranged between the holding projections and the free end of the holding sleeve opposed to the fixing section. Such a clamping projection can create an additional sealing effect between the holding sleeve and the outer sheathing of the hose end section.

In order to realize a simple possibility to define the position of the hose end fastened to the hose fitting—in its fastened state—as stop projection can be provided at the connecting element adjacent to the insert section, which projects radially outward and limits the axial length of the insert section.

It is further possible, that the distance between two adjacent holding projections in the axial direction corresponds essentially to the thickness of the hose wall. In that way, a strong connection between the hose fitting and the hose end section can be attained. It may further be advantageous for the insert section of the connecting element to include, at least partly, a ribbed outer surface for providing a good sealing contact with the inner sheathing of the hose end section in the fastened state of the hose fitting.

Additionally, if desired, the insertion of the insert section of the connecting element into the opening of the hose end section can be simplified by reducing the outer diameter of the insert section along its end section. Further, the outside diameter of said end section can be reduced conically towards the free end of the insert section.

### BRIEF DESCRIPTION OF THE DRAWINGS

Embodiments of the present invention are explained below with reference to the accompanying drawing, wherein:

FIG. 1 shows a first embodiment of the hose fitting in its original non-fastened state and

FIG. 2 shows a second embodiment of the hose fitting according to the present invention in fastened state.

### DETAILED DESCRIPTION OF THE INVENTION

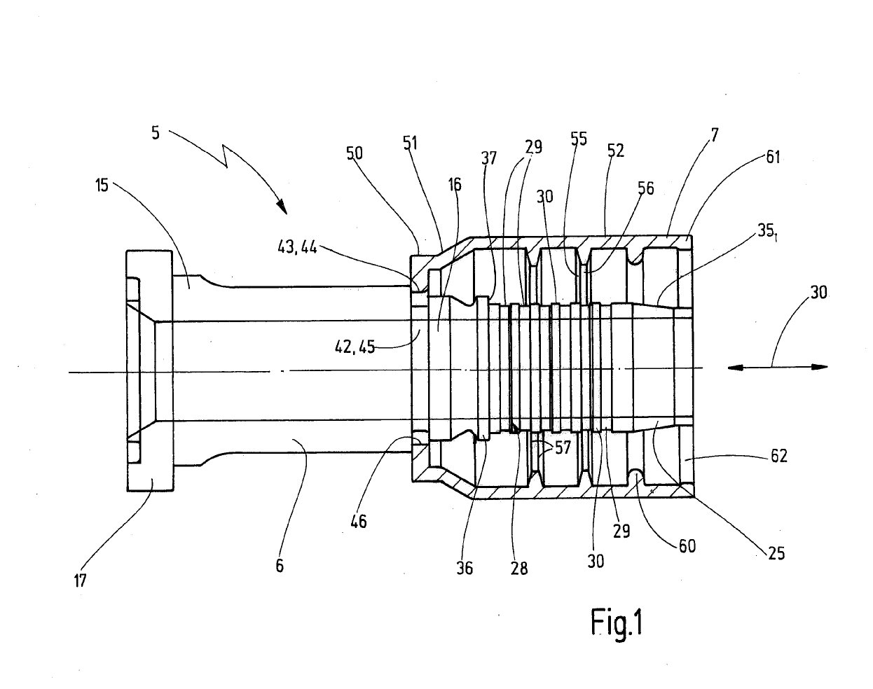

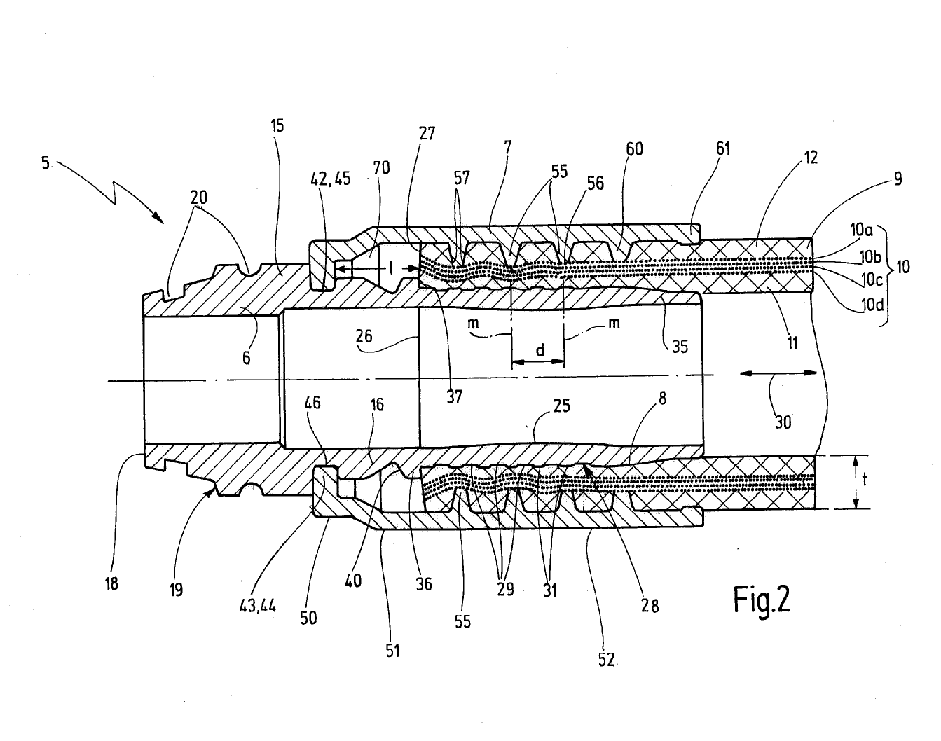

FIGS. 1 and 2 show a hose fitting 5 having a connecting element 6 and a holding sleeve 7, which work together to fasten the hose fitting 5 to a hose end section 8 of a hose 9, which can be seen in FIG. 2. As shown in the illustrated embodiments, the hose fitting 5 may consists of only two parts: the connecting element 6 and the holding sleeve 7. The connecting element 6 as well as the holding sleeve 7 can each be made of one single piece. No additional fixing means are provided in order to connect the holding sleeve 7 with the connecting element 6. The hose fitting 5 could thus be called a two-piece fitting.

The hose fitting 5 according to embodiments of the present invention is preferably used for high pressure applications, where the fluid pressure is particularly at least 400 bar. The hose 9 in such high pressure applications contains a reinforcement layer 10 arranged between an inner sheathing 11 and an outer sheathing 12. The reinforcement layer can for example be made of flexible metal wires and may consist of multiple tiers and contains four wire tiers 10a, 10b, 10c, 10d in the illustrated embodiment. Each winding of one of the wire tiers 10a, 10b, 10c, 10d may be placed to the adjacent winding of the same tier 10a, 10b, 10c, 10d without or only with a small axial distance. The helix angle of the wire of each tier is preferably smaller than 45°, more advantageously smaller than 30° and in a preferred embodiment smaller than about 10°, for example between 1 and 5°. Each wire tier 10a, 10b, 10c, 10d may have a different helix angle, but preferably the value of the helix angle of all wire tiers is essentially the same. The algebraic sign of the helix angle of the tiers may change—and thus the direction of the winding—with reference to a radial plane of the hose 9, in order that the wire tiers 10a, 10b, 10c, 10d form a netting. As shown in FIG. 2, the axial distance between two adjacent windings of one of the tiers 10a, 10b, 10c, 10d is essentially not greater than the thickness of the used wire.

The inner or outer sheathing 11, 12 may consist of an elastomer or rubber material. However, the invention is not so limited, and other hose constructions are also suitable for the hose fitting 5 according to the present invention.

The connecting element 6 is of a tubular shape and has a first end portion 15 and a second end portion 16. The first end portion 15 is configured to be connected to counter fitting means, which are not shown in the drawing. According to a first embodiment of the connecting element 6, generally shown in FIG. 1, a nut 17 may be arranged at the first end portion for connecting the connecting element 6 to the counter fitting means. The first end portion 15 according to the embodiment shown in FIG. 2 is of different shape whereby the outer diameter of the first end portion 15 is reduced to the free end 18 of the first portion 15. On the outside face 19 of the first portion 15 of the second embodiment of the connecting element 6 shown in FIG. 2, one or more annular grooves 20 are provided. The shape of the grooves 20 seen in the cross-section can be rectangular or semi-circular, or any other suitable shape. Such grooves may be used for sealing rings, snap-rings or other means used to connect the connecting element 6 sealingly to counter fitting means (not shown).

The second end portion 16 of the connecting element 6 may contain an insert section 25 which is provided to insert the connecting element 6 into the essentially circular opening 26 of the hose and 27. The outer diameter of the insert section 25 is adapted to the diameter of the opening 26 of the hose end section 8 in order to create a press fit. In order to attain a good sealing contact between the outer face 28 of the insert section 25 and the inner sheathing 11 of the hose end section 8, the outer face 28 may be ribbed and thus provides a plurality of annular openings 29, which may be spaced from each other in an axial direction 30 of the hose fitting 5. Between these annular openings 29, sealing ribs 31 are created that have an essentially rectangular cross-section according to an embodiment. If the hose fitting is in its fastening state, the material of the inner sheathing 11 of the hose end section 8 flows into the annular openings 29 of the insert section 25 and better ensures or guarantees a good sealing contact.

In order to simplify the insertion of the connecting element 6 into the hose end section 8, the insert section 25 has an end part 35 with a reduced outer diameter. According to the present embodiment, the end part 35 can, for example, be at least partly conically shaped. Other shapes in order to reduce the outer diameter are also possible.

Opposed to the end part 35, the insert section is limited in the axial direction 30 by means of a radially outward projecting stop 36, which can have a trapezoidal cross-section, for example as shown in FIG. 2. Other cross-sections are also suitable. The outer diameter of the stop 36 is greater than the outer diameter of the sealing ribs 31 of the insert section. An annular plane of the stop 36, arranged adjacent to the outer face 28 of the insert section 25 facing in the direction of the insert section 25 defines the abutment plane 37 for the hose end 27. The abutment plane 37 and the outer face 28 of the insert section 25 include an angle of about 90° in the illustrated embodiment. In the fastened state of the hose fitting 5, the hose end 27 is into contact with the abutment plane 37 of the stop 36. Apart from the described preferred embodiment, the stop 36 may have any other cross-section, for example, without limitation, a rectangular cross-section.

The connecting element 6 may have a fluid bore 39 which extends over the entire axial length of the connecting element 6. In the fastened state of the hose fitting 5, fluid can flow from the hose through the fluid bore 39 of the connecting element 6 to the counter fitting means of the hose fitting 5 (not shown) and vice versa.

Adjacent to the stop 36 an annular groove-like cavity 40 may be provided in the outside face of the connecting element 6. This cavity 40 can be part of a so called “wire trap” together with a corresponding tooth of a holding sleeve 7. Such a wire trap may require a peeled hose end section 8, so that the tooth of the holding sleeve can force the wire reinforcement layer of the hose 9 into the cavity 40 in order to generate a high holding force. A holding sleeve 7 having such a wire trap tooth is not shown in the drawing and does not form part of this invention. An advantage of the present inventive hose fitting 5 is that connecting elements 6 having a cavity 40 as part of a wire trap can be used without the need to design and produce a connecting element 6 without such cavity 40, even though the cavity 40 is not necessary for the inventive hose fitting 5.

At the intersection between the first end portion 15 and the second end portion 16 of the connecting element a fixing counter part 42 can be provided that is designed to cooperate with a deformable fixing part 43 of the holding sleeve 7 in order to undetachably fix the holding sleeve 7 to the connecting element 6. More specifically, according to a preferred embodiment, the fixing part of the holding sleeve 7 is formed by a radially inward projecting collar 44 of essentially rectangular cross-section. Accordingly the fixing counter part 42 may be formed by an annular groove 45, whereby the cross-section of the annular groove 45 can be adapted to the cross-section of the collar 44. Any other than a rectangular cross-section of the collar 44 and the groove 45 is also suitable for the hose fitting 5.

The holding sleeve 7 has essentially the form of a hollow cylinder or bushing, whereby the inner and outer diameter can change over the axial extend of the holding sleeve 7. The holding sleeve 7 may be jointless formed in its circumferential direction and according to the present embodiment made of one single piece. The inner diameter of the collar 44 is the smallest area of the holding sleeve 7. The inner diameter of collar 44 is greater than the outside diameter of any part of the second end portion 16 of the connecting element in order to be able to insert the connecting element 6 into a collar bore 46 defined by the annular collar 44. This state is generally shown in FIG. 1, whereby the holding sleeve 7 and the connecting element 6 are not fixed with each other yet. Only the second end portion 16 was inserted through the collar bore 46 of the holding sleeve 7.

The fixing part 43, formed by the collar 44 is arranged at one axial and of the holding sleeve 7. This end with the fixing part 43 forms an axial fixing section 50 of the holding sleeve 7.

Following to the fixing section 50, the holding sleeve 7 may have an intermediate section 51 and a deformable holding section 52. The holding section of the holding sleeve 7 is responsible for exerting a holding force on the hose end section 8, if the hose fitting 5 is in its fastened state. Therefore, the holding section 52 provides a plurality of radially inward projecting holding projections 55, which are spaced from each other in axial direction 30. According to a preferred embodiments shown in the drawing, preferably two or three holding projections 55 are arranged at the holding sleeve 7.

As shown in FIGS. 1 and 2, the holding projections 55 may have a trapezoidal cross-section, so that at its radially inner ends 56 two cutting edges 57 are formed. Apart from the shown preferred embodiments, a cross-section of the holding projections may have any other suitable shape, whereby at least one cutting edge at the inner end 56 of a holding projection 55 shall be provided.

The axial distance d between the middle axes of two adjacent holding projections 55 corresponds preferably essentially to the thickness t of the hose wall in order to provide a good holding force between the hose fitting 5 and the hose end section 8 in the fastened state as shown in FIG. 2. In a preferred embodiment, as generally illustrated in the drawing, the holding projections may be continuously annular shaped. Apart from that, it is also possible, that each holding projection 55 contains a plurality of holding teeth which are arranged over the periphery of the holding projection 55 and preferably evenly distributed over the periphery.

In addition to the holding projections 55, a radially inward projecting clamping projection 60 can be provided at the holding section 52. The clamping projection 60 has a rounded outline without sharp edges. The height of the clamping projection 60 in radial direction is essentially the same as the height of the holding projections 55, but can also be slightly smaller.

The clamping projection 60 is arranged at the holding section 52 of the holding sleeve 7 between a free end 61 of the holding sleeve 7, which is opposed to the other end of the holding sleeve 7 containing the fixing section 50. The free end 61 of the holding sleeve 7 can have a bulge-like finish, so that a slight bulge 62 projecting radially inward is formed. The bulge 62 can provide an additional clamping effect between the holding sleeve 7 and the outer sheathing 12 of the hose end section 8 in the fasten state of the hose fitting 5.

The intermediate section 51 of the holding sleeve 7, arranged between the fixing section 50 and the holding section 52 contains a conically shaped area so that the holding sleeve 7 is expanded from a smaller diameter of the fixing section 50 to a greater diameter of a holding section 52. The thickness of the wall of the holding sleeve 7 along the intermediate section 51 is essentially constant, so that both the inner diameter and the outer diameter are transferred from a small value of the fixing section 50 to a greater value of the holding section 52. This conically shaped part of the intermediate section 51 exists according to a preferred embodiment in the non-mounted date, where the holding sleeve 7 is not connected to the connecting element 6, as well as in the mounted state, where the holding sleeve 7 is undetachably fixed to the connecting element 6. In a modified, not shown embodiment, it would be also possible, that the conically shaped part of the holding sleeve 7 is generated during fixing the holding sleeve 7 to the connecting element 6.

To transfer the hose fitting 5, into the fastened state, where it is fastened to the hose end section 8, three fastening steps are executed sequentially: The originally non-mounted state is shown in FIG. 1. In a first fastening step, the second end portion 16 is inserted into the bore 46 of the holding sleeve 7 in order that the holding sleeve 7 is arranged coaxial to the second end portion 16 of the connecting element 6. The groove 45 of the connecting element 6 and collar 44 of the holding sleeve are aligned in the same axial position. By exerting a crimp force to the periphery of the fixing section 50, the collar 44 is engaging the groove 45 until the diameter of the bore 46 is reduced to the diameter of the ground of the groove 45. Thereby the holding sleeve 7 is deformed plastically. In this state, the holding sleeve 7 and the connecting element 6 are fixed with each other. This state could be named as pre-assembled state of the hose fitting 5.

During the fixing of the holding sleeve 7 to the connecting element 6, the holding section 52 is left undeformed. The intermediate section 51 separates the fixing section 50 from the holding section 52, so that the plastic deformation of the fixing section 50 has no deformation effect on the holding section 52.

In the next fastening step the hose end section 8 of the hose 9 is pushed into the annular free space between the insert section 25 of the connecting element 6 and the holding section 52 of the holding sleeve 7 until the hose end 27 comes into contact with the abutment plane 37 of the stop 36. In this inserted position the insert section 25 of the connecting element 6 is completely inserted into the hose end section 8. The hose end section 8 is left unpeeled, so that the complete thickness of the wall of the hose end section is available to create the holding force between the hose fitting 5 and the hose end section 8 in the next fastening step. According to a preferred embodiment, and as generally shown in FIG. 2, all three layers 10, 11, 12 in their entire thickness are arranged between the holding section 52 of the holding sleeve 7 and the insert section 25 of the connecting element 6.

In the last fastening step, a crimping force to the periphery of the holding section 52 of the holding sleeve 7 is exerted which deforms the holding section 52 plastically. Due to this, the holding projection 55 are moved radially inward and cut into the outer sheathing 9 of the hose end section. The holding projections intrude into the outer sheathing 12 of the hose end section, preferably until the inner ends 56 of the holding projections 55 reach the reinforcement layer 10 of the hose end section. With the holding projections 55 intruded into the outer sheathing 12 of the hose end section 8 a good holding force is created between the hose fitting 5 and a hose end section 8. The hose fitting 5 is in its fastened state.

In this fastened state of the hose fitting 5, an axial clearance 70 exists between the hose end 27 and the fixing part 43 formed by the collar 44. The axial length 1 of the clearance 70 according to the illustrated embodiment, is greater than the axial distance d between the radially extending midplanes m of two adjacent arranged holding projections 55. The axial length 1 can for example have values between 1 and 3 cm, particularly about 2 cm.

Because of the clearance 70 an annular gap is created around the connecting element 6 which is covered or bridged radially outward by the intermediate section 51 of the holding sleeve 7. No material of the hose end section 8 is located in the annular gap created by the clearance 70 in the fastened state of the hose fitting.

What is claimed is:

1. A hose fitting for a hose, the hose fitting comprising:
a connecting element, and
a holding sleeve for fastening the hose fitting to a hose end section;
the connecting element having an insert section that is configured to be inserted into the opening of the hose end section,
the holding sleeve having a deformable fixing section at its one end with a fixing part configured to engage a fixing counter part of the connecting element to fix the holding sleeve to the connecting element after deformation of the fixing section,
the holding sleeve having a holding section with radially inward projecting holding projections, each holding projection having at least one cutting edge, and an intermediate section between the fixing section and the holding section,
whereby, in a fastened state where the hose fitting is fastened to the hose end section, the holding projections intrude into the outer sheathing of the hose end section to fix it and an axial clearance between the hose end and the fixing part is provided.

2. A hose fitting according to claim 1, wherein the axial length of the clearance is greater than the axial distance between two adjacent arranged holding projections.

3. A hose fitting according to claim 1, wherein the intermediate section is at least partly conically shaped, particularly if the hose fitting is in its fastened state.

4. A hose fitting according to claim 3, wherein the wall of the intermediate section of the holding sleeve has an essentially constant thickness.

5. A hose fitting according to claim 1, wherein in the fastened state of the hose fitting, the holding projections intrude into the outer sheathing of the hose end section until the radially inner ends of the holding projections reach a reinforcement layer of the hose end section, which contain metal wires.

6. A hose fitting according to claim 1, wherein the holding sleeve provides a clamping projection, which is projecting radially inward from the holding section and axially arranged between the holding projections and the free end of the holding sleeve opposed to the fixing section.

7. A hose fitting according to claim 1, wherein a radially outward projecting stop is provided at the connecting element adjacent to the insert section, limiting the axial length of the insert section and defining the position of the hose end in the fastened state of the hose fitting.

8. A hose fitting according to claim 1, wherein the hose has a wall thickness, and the distance between two adjacent holding projections in the axial direction correspond essentially to the thickness of the hose wall.

9. A hose fitting according to claim 1, wherein the insert section of the connecting element has at least partly a ribbed outer surface.

10. A hose fitting according to claim 1, wherein the outer diameter of the insert section is reduced along an end part of the insert section.

11. A hose fitting according to claim 1, wherein the hose is a flexible wire reinforced hose.

12. A method for fastening a hose fitting to a hose end section of a flexible wire reinforced hose, the method comprising:
fixing a holding sleeve to a connecting element by means of crimping of a fixing section of the holding sleeve to bring the fixing part into engagement with the fixing counter part of the connecting element,
inserting an insert section of the connecting element into an opening of the hose end section until the hose end reaches a radially outward projecting stop limiting the axial length of the insert section, and
crimping a holding section of the holding sleeve until holding projections intrude into an outer sheathing of the hose end section such that an axial clearance between the hose end and the fixing part is provide in the fastened state of the hose fitting.
